(19) United States
(12) Patent Application Publication
(10) Pub. No.: US 2009/0217881 A1
(43) Pub. Date: Sep. 3, 2009

(54) Pet water cooler

(76) Inventor: Martin Chambers, Little Rock, AR (US)

Correspondence Address: Martin Chambers, 4721 Maritime Cove, Garland, TX, 75043-8702, US

(21) Appl. No.: 11/860,517

(22) Filed: Mar. 3, 2008

(51) Int. Cl. A01K 7/00

(52) U.S. Cl. 119/73

(57) ABSTRACT

A water container for pets or other animals which has a container or reservoir for holding a supply of water. The container is secured to a bowl or tray into which the reservoir will feed water. The reservoir usually has only a single opening or orifice for the water to be released into the tray this orifice is usually placed in the tray such that water flows out of the reservoir into the tray until an equilibrium is reached between the level of the water in the tray and the remaining water in the reservoir. As the pet drinks water from the tray additional water is released from the reservoir to refill the container until a new equilibrium is achieved. This continues until all the water is removed from the reservoir and flows into the tray. The reservoir has double wall structure with an insulator between the walls to keep the water in the reservoir cool and, therefore, appealing to the pet.

Applicant claims priority of Provisional application Ser. No. 60/835,195, filed Sep. 25, 2006.

### BACKGROUND OF THE INVENTION

This invention relates, in general, to pet items and, in particular, to a water cooler for a pet.

### DESCRIPTION OF THE PRIOR ART

Today, many households frequently have one or more pets, usually dogs and/or cats. One of the problems frequently encountered by pet owners is there is not always someone home at the necessary times to attend to the basic needs of the family pet, i.e., food and water. The pet owner may be away for portions of the day working, at school or attending to other matters. Frequently, the pet owner can make arrangements for the pet to be cared for by a friend, neighbor or other family member that will look in on the pet problem. The feeding schedule for many pets can usually be arranged to be at convenient times for both the owner and the pet. Many pets generally eat at the same time each day and the pet owner can arrange his or her schedule to meet the needs of the pet. There are also products that are currently available for the pet owner to use to dispense quantities of food as needed by the pet.

Although pets can be feed at certain times during the day, the same is not true for the pet's fluid needs. During the hot summers and other times during the year, the pet may need to receive water or other fluids on an as needed basis in order to maintain the pet's health. As a result, many owners rely on pet water dishes to provide the pet with water throughout the day. Many pet water dishes are merely a bowl that is placed on the floor or other convenient spot to provide the pet with fluids. A mere bowl may not be sufficient for larger pets or during hot weather or when the owner is not going to be present for an extended period. In these instances, there is a need for a bowl with a larger reservoir of water. Whit it is possible to provide a larger bowl for the pet, a larger bowl is problematical. For example, a larger bowl is more difficult to transport from the filling area to the pet's drinking location. The more water present increases the risk of spilling the water even after the bowl has been transported. Once the bowl is placed in position, a large bowl presents problems for the pet owner. Many dogs are not particularly neat or careful when imbibing and the more water present increases the risk of water dripping where it is not desired. Also, many pets have a tendency to tip the bowl over spilling the contents.

Another problem with the large quantities of water occurs where more water is present than the pet can conveniently drink over a reasonable period of time. In those instances, the water can become contaminated with debris thus rendering it unpalatable or even unhealthy. Particles of food and other items have a tendency to be dropped into the water by the pet which soils the water and create a breeding ground for bacteria and contagion. Another problem that occurs is if the pet's dish is in a location where it will be heated by the sun, the pet may not want to drink warm water. As a result, there have been a number of attempts to solve the problem of providing sufficient fresh water to a pet for extended periods of time.

In addition to domestic pets, other animals are supplied with water by bowls that remain usually in place for days, and must periodically be cleaned and replenished. Such other contexts include zoo animals, animals housed in kennels, and many farm animals. In general, larger animals require larger containers, sometimes shaped more like a deep trough, than a bowl. The invention described herein can also be used with zoo, farm and kennel type water containers.

### SUMMARY OF THE INVENTION

The present invention is directed to a water container for pets or other animals which has a container or reservoir for holding a supply of water. The container is secured to a bowl or tray into which the reservoir will feed water. The reservoir usually has only a single opening or orifice for the water to be released into the tray this orifice is usually placed in the tray such that water flows out of the reservoir into the ray until equilibrium is reached between the level of the water in the tray and the remaining water in the reservoir. As the pet drinks water from the tray, additional water is released from the reservoir to refill the container until a new equilibrium is achieved. This continues until all the water is removed from the reservoir and flows into the tray. The reservoir has a double wall structure with an insulator between the walls to keep the water in the reservoir cool, and therefore, appealing to the pet.

It is an object of the present invention to provide a new and improved pet water container that can supply sufficient quantities of water to a pet over a period of time.

It is an object of the present invention to provide a new and improved pet water container that maintains the temperature of the water regardless of the location of the pet water container.

It is an object of the present invention to provide a new and improved pet water container that is easy to fill.

These and other objects and advantages of the present invention will be fully apparent from the following description, when taken in connection with the annexed drawings.

### BRIEF DESCRIPTION OF THE DRAWINGS

FIG. 1 is a perspective view of the present invention.

### DESCRIPTION OF THE PREFERRED EMBODIMENT

The preferred embodiment herein described is not intended to be exhaustive or to limit the invention to the precise form disclosed. It is chosen and described to best explain the invention so that others skilled in the art to which the invention pertains might utilize its teachings.

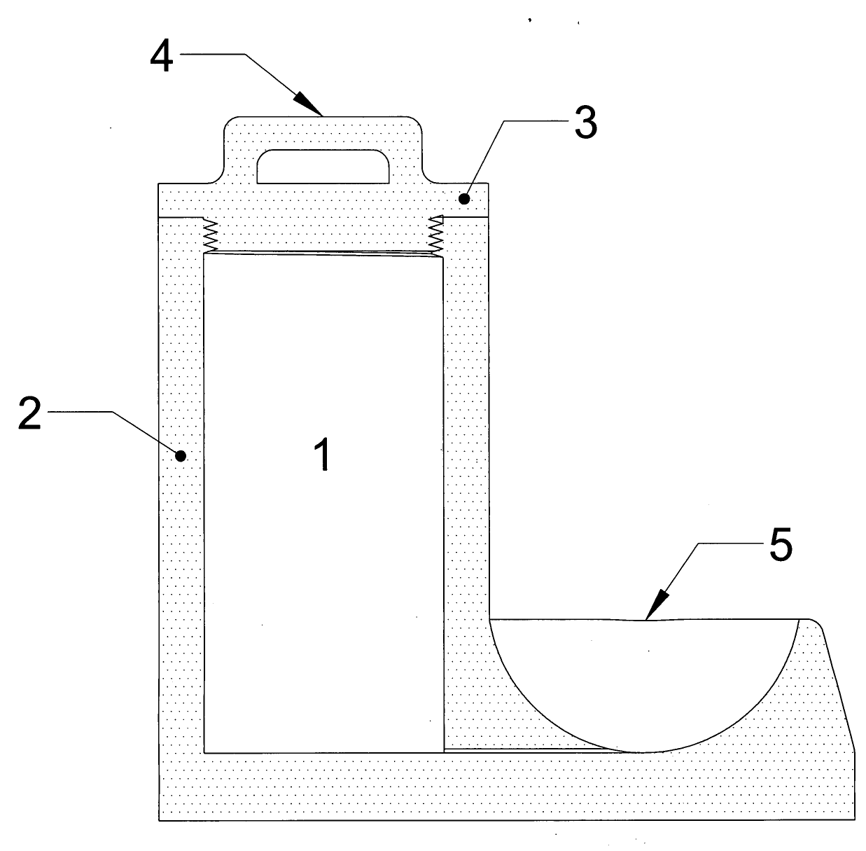

Referring now to the drawings in greater detail, FIG. 1 shows the pet cooler 1 of the present invention. The cooler comprises a container or reservoir 2 which can be made from any suitable material, however, plastic is the preferred material. Also, it should be noted that the container 2 is shown as circular, however, this is merely for illustrational purposes and, other shapes can be used without departing from the scope of the invention. The container has a lid 3 with a handle 4 secured to the lid in any conventional manner. The handle can be used to remove the lid from the container 2.

The container 2 has a tray or water dish 5 attached. It should be noted that the container and tray can be formed as a unitary unit or they can be formed as separate units and secured together in any conventional manner. The tray 5 has a top rim 9 and a bottom 10 which will form a dish to receive the water for the pet. The container 2 has an aperture 6 which opens to the interior of the container.

As shown in FIG. 2 the container 2 is made as a double wall container. The container has an outer wall, which forms the outside surface of the container, and an inner wall 8. The two walls form a space there between which is filled with an insulating material 7. A foam insulation is the preferred material since it can be placed inside the space between the walls and allowed to expand. This will prevent any voids from forming to produce hot spots.

In order to use the invention, the lid 3 is removed from the container 2 and the container is then filled with water and ice, and the lid is replaced. Where there is a removable lid 3 as well as the orifice 6 for dispensing water, the lid that covers the container 2 must be relatively impermeable to air entering the container. If it is not, the pressure of the air entering the container 2 through this permeable lid 3 forces all the water in the container to flow into the tray. As a result, the lid 3 on the container 2 is preferably a tight one to retain the temperature of the ice and water inside the container. The lid 3 is hand tighten which would allow the lid 3 to be removed easily once the water is gone from the tray or water dish 5 and for cleaning purposes.

Once the container 2 is one-fourth filled with water, the aperture 6 which is located at the bottom of the container fills the tray or water dish 5 from the bottom up. When water flows out of the container into the tray or water dish 5, equilibrium is reached between the levels of the water in the tray and the remaining water in the container 2. As the pet drinks water from the tray or water dish, additional water flows from the container 2 to refill the tray or water dish until a new equilibrium is achieved. This continues until all the water is removed from the container and flow into the tray.

Although the Pet Water Cooler and the method of using the same according to the present invention has been described in the foregoing specification with considerable details, it is to be understood that modifications may be made to the invention which do not exceed the scope of the appended claims. Modified forms of the present invention done by others skilled in the art to which the invention pertains will be considered infringements of this invention when those modified forms fall within the claimed scope of the invention.

What I claim as my invention is:

1. A pet water cooler comprising:
A container for holding a fluid,
Said container extending upwardly from a dish,
Said container comprising a top and side walls extending from said dish to said top,
An orifice in a side wall of said container,
Said container communication with an interior of said container for passing fluid from an interior of said container to said dish, and
Wherein said container has inner walls and outer walls,
A space formed between said inner and outer walls, and
An insulation is placed in said space.

2. The pet water cooler as claimed in claim 1, wherein said insulation is a foam insulation.

3. The pet water cooler as claimed in claim 1, wherein said container has a lid attached to and removable from an end of said container.

4 The pet water cooler as claimed in claim 3, wherein said lid has a handle.

5 The pet water cooler as claimed in claim 1, wherein said dish has a upper rim, and said orfice is positioned below said upper rim.
